(19) United States
(12) Patent Application Publication
(10) Pub. No.: US 2025/0335548 A1
(43) Pub. Date: Oct. 30, 2025

(54) CLASSIFICATION PROCESS EVALUATION

(71) Applicant: AUTOBRAINS TECHNOLOGIES LTD., Tel Aviv -Yafo (IL)

(72) Inventors: Tomer Cohen, Tel Aviv -Yafo (IL); Idan Geller, Tel Aviv -Yafo (IL); Igal Raichelgauz, Tel Aviv -Yafo (IL)

(73) Assignee: AUTOBRAINS TECHNOLOGIES LTD., Tel Aviv -Yafo (IL)

(21) Appl. No.: 18/645,144

(22) Filed: Apr. 24, 2024

(51) Int. Cl. G06F 18/24

(52) U.S. Cl. CPC G06F 18/24

(57) ABSTRACT

A method for classification process evaluation, the method includes (a) receiving, at a processing circuit, classification data generated by a classification process for augmented versions of a test sensed information unit; (b) evaluating the classification data across the augmented versions, by analyzing a distribution of, at least, selected classification values of the classification data; (c) determining, based on the evaluation, a compatibility of the classification process with respect to the received classification data; and (d) issuing a compatibility indication in accordance with the determined compatibility, the compatibility indication indicative of the compatibility of the classification process to classify an element captured by the sensed information unit.

### FIELD OF DISCLOSURE

The present disclosure relates to the field of computer technology, and more particularly, to a method, non-transitory computer-readable storage medium and computer-implemented system for visualizing a latent representation of a neural network model.

### BACKGROUND

Assisted and autonomous driving systems are known in the art. In such systems, computer implemented systems control (at least to some extent) some, or all, of a vehicle's driving functions, e.g., speed, telemetry, braking, etc. The vehicle is typically equipped with one or more sensors to provide the system with sensed information regarding the driving environment. The sensed information for the driving environment is typically used by the driving system to determine how to drive on roadways.

One of the major tasks related to driving is classifying.

The sensed information may be acquired and/or processed under different conditions-such as different sensing conditions and/or different sensed information processing parameters and/or noise.

Therefore, there is a growing need to provide a robust classification that may provide consistent classification results despite the different conditions.

### SUMMARY

The present disclosure provides a method, non-transitory computer-readable storage medium and computer-implemented system for evaluating the image classification process.

In a first aspect of the present disclosure, a method that is computer implemented for classification process evaluation, including receiving, at a processing circuit, classification data generated by a classification process for augmented versions of a test sensed information unit; evaluating the classification data across the augmented versions, by analyzing a distribution of selected classification values of the classification data; determining, based on the evaluation, a compatibility of the classification process with respect to the received classification data; and issuing a compatibility indication in accordance with the determined compatibility, the compatibility indication indicative of the compatibility of the classification process to classify an element captured by the test sensed information unit.

In another aspect of the present disclosure, a non-transitory computer readable medium for classification process evaluation, the non-transitory computer readable medium stores instructions that once executed by a computerized system cause the object computerized system to: receive classification data generated by a classification process for augmented versions of a test sensed information unit; evaluate the classification data across the augmented versions, by analyzing a distribution of selected classification values of the classification data; determine, based on the evaluation, a compatibility of the classification process with respect to the received classification data; and issue a compatibility indication in accordance with the determined compatibility, the compatibility indication indicative of the compatibility of the classification process to classify an element captured by the test sensed information unit.

In yet another aspect of the present disclosure, A computerized system of classification process evaluation, the computerized system includes: a memory unit that is configured to store classification data generated by a classification process for augmented versions of a test sensed information unit; and a processing circuit that is configured to: evaluate the classification data across the augmented versions, by analyzing a distribution of selected classification values of the classification data; determine, based on the evaluation, a compatibility of the classification process with respect to the received classification data; and issuing a compatibility indication in accordance with the determined compatibility, the compatibility indication indicative of the compatibility of the classification process to classify an element captured by the test sensed information unit.

It should be understood that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### A BRIEF DESCRIPTION OF THE DRAWINGS

The embodiments of the disclosure will be understood and appreciated more fully from the following detailed description, taken in conjunction with the drawings in which:

FIG. 1A illustrates a block diagram of a computerized system within a vehicle, in accordance with some embodiments of the present disclosure;

FIG. 1B is a block diagram of a computerized classification system within a vehicle, in accordance with some embodiments of the present disclosure;

FIG. 2 is a flowchart illustrating an exemplary method of classifying data and determining a compatibility of the classification, in accordance with some embodiments of the present disclosure;

FIG. 3 is a block diagram of a system that perform a method of classifying and determining compatibility of the classification, in accordance with some embodiments of the present disclosure;

FIG. 4 is an example of sensed information including a sensed image and various information elements associated with the sensed image, in accordance with some embodiments of the present disclosure;

FIG. 5 is an example of sensed information including a sensed image, and keypoints and a cropped image associated with the sensed image, in accordance with some embodiments of the present disclosure; and

FIG. 6 is an example of sensed information including a sensed image, a cropped image and various information elements associated with the sensed image, in accordance with some embodiments of the present disclosure.

### DETAILED DESCRIPTION

Embodiments of the disclosure are described in detail with the technical matters, structural features, achieved objects, and effects with reference to the accompanying drawings as follows. Specifically, the terminologies in the embodiments of the present disclosure are merely for the purpose of describing certain embodiments, but not to limit the disclosure. In the following detailed description, numerous specific details are set forth to provide a thorough understanding of the disclosure. However, it will be understood by those skilled in the art that the present disclosure may be practiced without these specific details. In other instances, well-known methods, procedures, and components have not been described in detail so as not to obscure the present disclosure. The subject matter regarding the disclosure is particularly pointed out and distinctly claimed in the concluding portion of the specification. The disclosure, however, both as to organization and method of operation, together with objects, features, and advantages thereof, may best be understood by reference to the following detailed description when read with the accompanying drawings. Because the illustrated embodiments of the present disclosure may for the most part, be implemented using electronic components and circuits known to those skilled in the art, details will not be explained in any greater extent than that considered necessary as illustrated above, for the understanding and appreciation of the underlying concepts of the present disclosure and in order not to obfuscate or distract from the teachings of the present disclosure. For example, the specification and/or drawings may refer to a processor or to a processing circuitry. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

The following specification and/or drawings may refer to an image or an image frame. An image is an example of a media unit. Any reference to an image may be applied mutatis mutandis to a media unit. A media unit may be an example of a Sensed Information Unit (SIU). Any reference to a media unit may be applied mutatis mutandis to any type of natural signal such as but not limited to signal generated by nature, signal representing human behavior, signal representing operations related to the vehicle signals, geodetic signals, geophysical signals, textual signals, numerical signals, time series signals, and the like. Any reference to a media unit may be applied mutatis mutandis to the SIU. The SIU may be of any kind and may be sensed by any type of sensors-such as a visual light camera, an audio sensor, a sensor that may sense infrared, radar imagery, ultrasound, electro-optics, radiography, Light Detection and Ranging (LIDAR), a thermal sensor, a passive sensor, an active sensor, etc. The sensing may include generating samples (e.g., pixel, audio signals, etc.) that represent the signal that is transmitted, or otherwise reach the sensor. The SIU may have one or more images, one or more video clips, textual information regarding the one or more images, text describing kinematic information, and the like.

Any combination of any module or unit listed in any of the figures, any part of the specification and/or any claims may be provided. Any one of the units and/or modules that are illustrated in the application, may be implemented in hardware and/or code, instructions and/or commands stored in a non-transitory computer readable medium, may be included in a vehicle, outside a vehicle, in a mobile device, in a server, and the like. The vehicle may be any type of vehicle—for example a ground transportation vehicle, an airborne vehicle, or a water vessel. The vehicle is also referred to as an ego-vehicle. It should be understood that the autonomous driving includes at least partially autonomous (semi-autonomous) driving of a vehicle, which includes all the L2 level types or higher defined in the SAE standard.

There is provided a method, a system and a computer readable medium that are robust and are configured to provide a robust classification despite changes in one or more conditions associated with an obtaining and/or processing in sensed information unit.

According to an embodiment the classification values associated with augmented versions of a sensed information unit are evaluated to determine whether the classification process provides consistent classification values despite the changes introduced by the augmentation.

According to an embodiment, the classification process is evaluated during a test phase that follows a training phase but may precede inference. Finding an inadequate classification processing during the test phase—especially before inference—reduces classification errors that may lead to accidents.

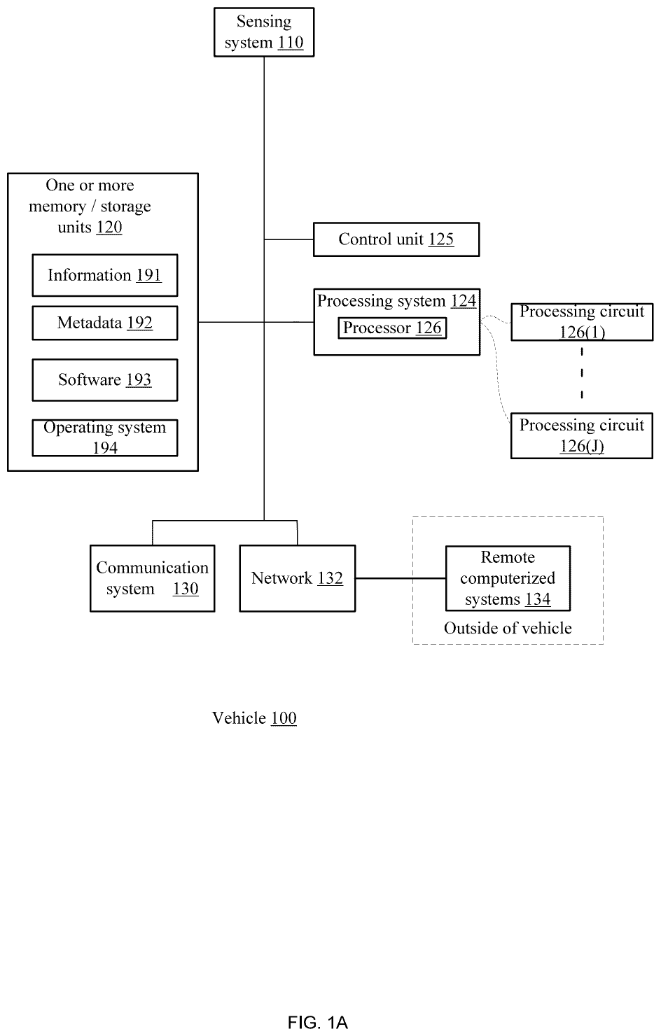

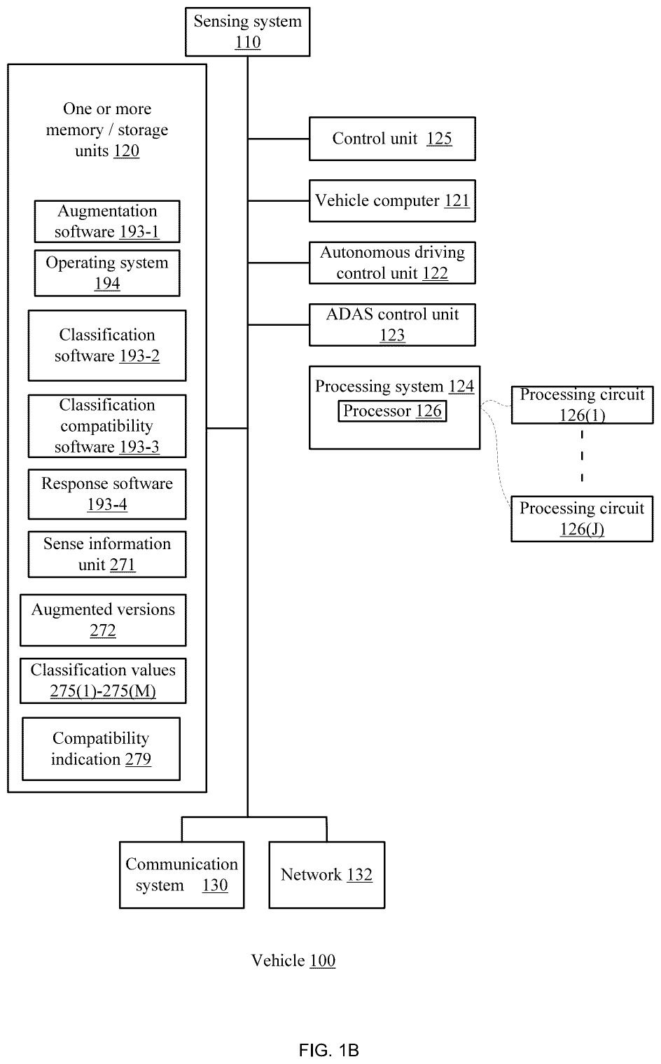

Referring to FIGS. 1A-1C, a vehicle 100 including a sensing system 110, a communication system 130, one or more memory and/or storage units 120, network 132, control unit 125, and processing system 124 having processor a 126 that includes a plurality of processing circuits 126(1)-126(J); and a remote computerized system 134, which may be located outside of the vehicle, are shown.

The one or more memory and/or storage units 120 are illustrated as storing an operating system 194, software 193 (especially software required to execute method 200), information 191 and metadata 192 (especially information and metadata required to execute method 200). The information may include environmental information. The metadata may include any metric or an outcome of processed information-especially related to the execution of method 200.

Network 132 is in communication with the vehicle and with the remote computerized systems 134 such as servers, cloud computers, and the like.

The control unit 125 is configured to control various operations related to the vehicle—such as but not limited to various steps of method 200.

The one or more memory and/or storage units 120 are illustrated as storing an operating system 194, software 193 (especially software required to execute method 200), information 191 and metadata 192 (especially information and metadata required to execute method 200). The information may include environmental information. The metadata may include any metric or an outcome of processed information-especially related to the execution of method 200.

FIGS. 1B and 1C differ from FIG. 1A by including additional units such as ADAS control unit 123, autonomous driving control unit 122, and vehicle computer 121, and by including more examples of content stored in the one or more memory and/or storage units 120.

The sensing system 110 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 110 is configured to output one or more Sensed Information Units (SIUs).

The ADAS control unit 123 is configured to control ADAS operations.

The autonomous driving control unit 122 is configured to control autonomous driving of the autonomous vehicle.

The vehicle computer 121 is configured to control the operation of the vehicle-especially controlling the engine, the transmission, and any other vehicle system or component.

The processing system 124 may include processor 126 and one or more other processors and is configured to execute any method illustrated in the specification.

According to an embodiment, there is provided a computerized system that includes a memory unit and a processing circuit (e.g., processor 126). The memory unit is configured to store classification data generated by a classification process for augmented versions of a test sensed information unit.

The processing circuit is configured to evaluate the classification process of the neural network across by evaluating the classification data of the augmented versions, by analyzing a distribution of, at least, selected classification values of the classification data.

The selected classification values may be all the classification values or only a part of the classification values. The selection can be made in any manner—for example the selection may be applied in an iterative manner in which a first set of classification values is selected and evaluated (by executing a next step of the evaluation process)—wherein a lack of statistical significant classification values of the first set may deem the classification process is incompatible—without needing to evaluate a second set of classification values. The first set may include 10, 20, 30, 40, 50, 60 percent of the classification values.

According to an embodiment, the augmented versions are generated by one or more machine learning processes, and/or include at least one of applying different augmentation parameters such as at least one cropping parameter, at least one color condition, at least one warping condition, at least one distortion condition. For example—by performing random cropping of an image and feeding only a portion of the cropped image (for example 70, 80 or 90 percent of the cropped image) back to the network.

According to an embodiment, the processing circuit analyzes the distribution by at least one of the following criteria:
a. Determining whether all the classification values are equal to each other (indicate of a presence of the same element within the augmented versions of a test sensed information unit).
b. Determined whether all the classification values are similar to each other. Similar mean that they either identify the same element or identify elements that are defined to be similar to each other—for example—different types of pedestrians (for example—of different age, of different size, and the like) can be defined to be similar to each other, different types of vehicles (for example vehicle of the same manufacturer, of the same purpose—whereas different purposes may refer to SUVs—minivans—buses—family cars, and the like) can be defined as similar to each other.
c. Determining whether at least a defined percentile of the classification values is equal to each other (or at least similar to each other).
d. Determining whether at least a defined number of the classification values are equal to each other (or at least similar to each other).
e. Determining whether a number of different classification values are below a defined threshold.
f. Determine whether the classification values are statistically significant.

According to an embodiment, the processing circuit is configured to determine, based on the evaluation, a compatibility of the classification process with respect to the received classification data.

According to an embodiment, the determining includes evaluating any of the criteria (a)-(f) listed above—or any other criterion.

According to an embodiment, the processing circuit is configured to determine that the classification process is compatible with respect to the received classification data when one or more criteria of is fulfilled—for example (referring to criteria (a) and (c)) whether all classification values (or at least a defined number) are equal to each other. The same applied to any other criteria of (b) and (d)-(f).

According to an embodiment, the processing circuit is configured to respond to the determination.

According to an embodiment, the response includes at least one of:
a. Issuing a compatibility indication in accordance with the determined compatibility, the compatibility indication indicative of the compatibility of the classification process to classify an element captured by the sensed information unit.
b. Triggering an allocation of another classification process to classify the test sensed information contingent on the determined compatibility.
c. Routing the augmented versions of a test sensed information unit to the other classification process.
d. Allocating another classification process to classify the test sensed information contingent on the determined compatibility.
e. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively—the driving related operation is an ADAS operation such as suggesting a driving scheme operation of performing a more limited driving related operation (limited in the sense of its duration).
f. Executing a driving related operation.
g. Triggering executing a driving related operation.
h. Determining a navigation path of the vehicle.
i. Triggering a determining a navigation path of the vehicle
j. Sending to one or more artificial intelligence agents information regarding the classification.
k. Triggering a sending to one or more artificial intelligence agents information regarding the classification
l. Activating one or more artificial intelligence agents based on the classification
m. Triggering an activating one or more artificial intelligence agents based on the classification

According to an embodiment, the triggering includes transmitting a signal other than the compatibility indication. The signal may be an interrupt request signal, an arbiter request signal or any other electronic and/or optical signal.

According to an embodiment, the processing circuit executes the classification process to provide the classification data.

According to an embodiment, another processing circuit executed the classification process.

According to an embodiment, the classification process is an embedding based classification process.

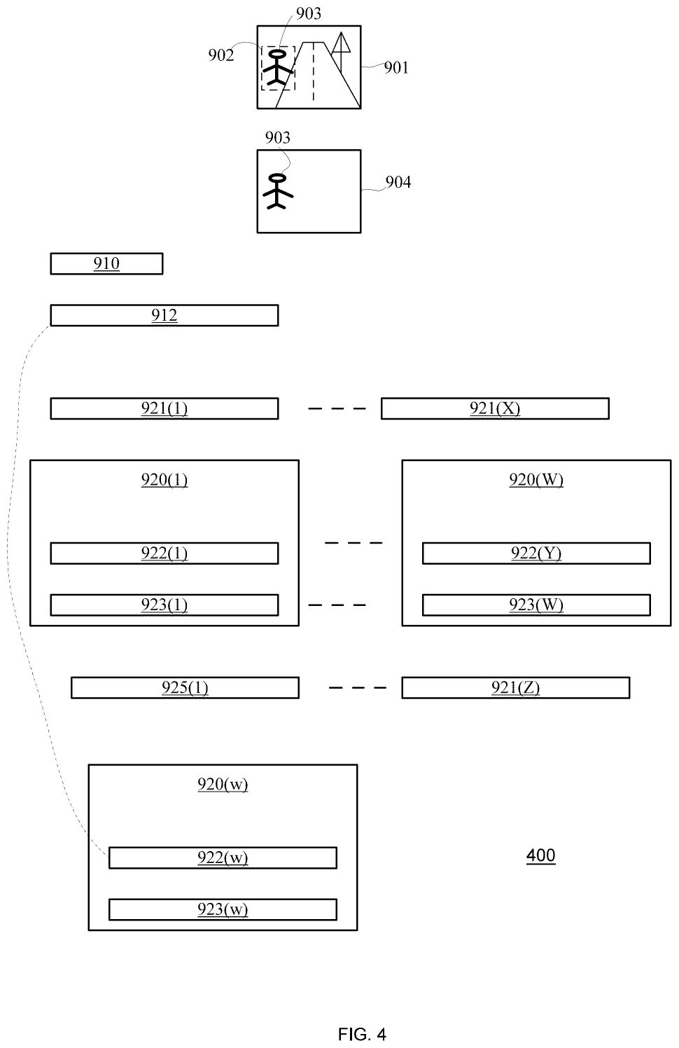

An example of an embedding based classification process is also illustrated in FIGS. 4-6, which will be described in more detail below.

The different figures illustrate examples of units and/or software and/or information items and/or steps and/or components. These examples are provided for brevity of explanation. At least one of the units and/or software and/or information items and/or steps and/or components is optional or mandatory.

The one or more memory and/or storage units 120 are configured to store firmware and/or software, one or more operating systems, data and metadata required to the execution of any of the methods mentioned in this application.

Referring specifically now to FIG. 1B, one or more memory and/or storage units 120 as storing at least some of:
a. Augmentation software 193-1 for generating the augmented versions of the sensed information unit.
b. Operating system 194.
c. Classification software 193-2 for applying one or more classification processes-to be evaluated during testing.
d. Classification compatibility software 193-3 for determining that a classification process is compatible with respect to the received classification data.
e. Response software 193-4 for responding to the determination.
f. Sensed information unit 271—which may be a test sensed information unit.
g. Augmented versions 272 of the sensed information unit.
h. Classification values 275(1)-275(M).
i. Compatibility indication 279.

The vehicle computer 121 may be in communication with an engine control module, a transmission control module, a powertrain control module, and the like

The memory and/or storage units 120 was shown as storing software. Any reference to software should be applied mutatis mutandis to code and/or firmware and/or instructions and/or commands, and the like.

According to an embodiment, the one or more memory and/or storage units 120 includes one or more memory unit, each memory unit may include one or more memory banks.

According to an embodiment, the one or more memory and/or storage units 120 includes a volatile memory and/or a non-volatile memory. The one or more memory and/or storage units 120 may be a Random-Access Memory (RAM) and/or a Read Only Memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, Digital Versatile Disks (DVD) or other optical storage, Random Access Memories (RAM), Read Only Memories (ROM), Electrically Erasable Programmable Read-Only Memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 130. Other communication elements may be provided.

Referring now to FIGS. 1A and 1B, communication system 130 may be in communication with various processors and/or units and network 132.

The communication system 130 may include a bus. The represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 132 that is located outside the vehicle and is used for communication between the vehicle and at least one remote computing system. By way of example, a remote computing system can be a personal computer, a laptop computer, portable computer, a server, a router, a network computer, a peer device or other common network node, and so on. Logical connections between the processor and either one of remote computing systems can be made via a Local Area Network (LAN) and a general Wide Area Network (WAN). Such network connections can be through a network adapter (may belong to communication system 130) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 120 may be stored outside the vehicle. It should also be noted that the processor may evaluate signatures generated by a plurality of detectors.

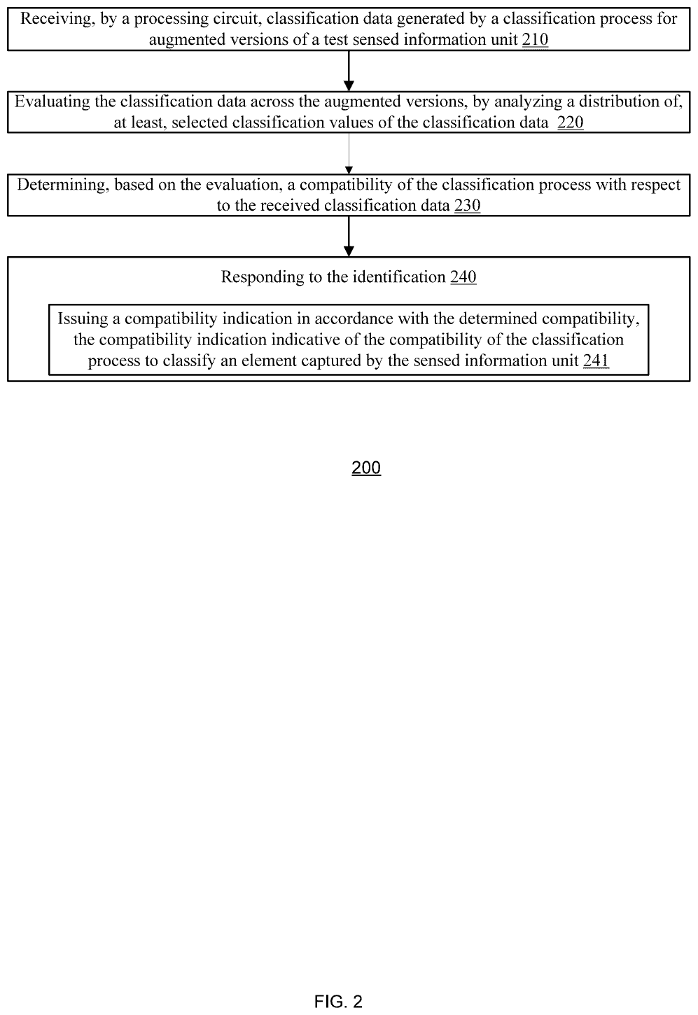

Referring to FIG. 2, a flowchart illustrating a method 200 of classifying data and determining a compatibility of the classification is shown. At 210, classification data generated by a classification process for augmented versions of a test sensed information unit is received by a processing circuit.

Next, at 220, the classification data across the augmented versions is evaluated, by analyzing a distribution of, at least, selected classification values of the classification data. The selected classification values may be all the classification values or only a part of the classification values. The selection can be made in any manner—for example the selection may be applied in an iterative manner in which a first set of classification values is selected and evaluated (by executing a next step of the evaluation process)—wherein a lack of statistical significant classification values of the first set may deem the classification process is incompatible—without needing to evaluate a second set of classification values. The first set may include 10, 20, 30, 40, 50, 60 percent of the classification values.

According to an embodiment, the augmented versions are generated by one or more machine learning processes, and/or include at least one of applying different augmentation parameters such as at least one cropping parameter, at least one color condition, at least one warping condition, at least one distortion condition. For example—by performing random cropping of an image and feeding only a portion of the cropped image (for example 70, 80 or 90 percent of the cropped image) back to the network.

According to an embodiment, step 220 may further include analyzing the distribution by at least one of the following criteria:
a. Determining whether all the classification values are equal to each other (indicate of a presence of the same element within the augmented versions of a test sensed information unit).
b. Determined whether all the classification values are similar to each other. Similar mean that they either identify the same element or identify elements that are defined to be similar to each other—for example—different types of pedestrians (for example—of different age, of different size, and the like) can be defined to be similar to each other, different types of vehicles (for example vehicle of the same manufacturer, of the same purpose—whereas different purposes may refer to SUVs—minivans—buses—family cars, and the like) can be defined as similar to each other.
c. Determining whether at least a defined percentile of the classification values are equal to each other (or at least similar to each other).
d. Determining whether at least a defined number of the classification values are equal to each other (or at least similar to each other).
e. Determining whether a number of different classification values are below a defined threshold.
f. Determine whether the classification values are statistically significant.

Thereafter, at 230, based on the evaluation, a compatibility of the classification process is determined with respect to the received classification data.

According to an embodiment, the determining includes evaluating any of the criteria (a)-(f) listed above—or any other criterion.

According to an embodiment, step 230 may include determining that the classification process is compatible with respect to the received classification data when one or more criteria of is fulfilled—for example (referring to criteria (a) and (c)) whether all classification values (or at least a defined number) are equal to each other. The same applied to any other criteria of (b) and (d)-(f).

Further, at 240 the determination is responded to. According to an embodiment, step 240 may include at least one of:
a. Issuing (step 241) a compatibility indication in accordance with the determined compatibility, the compatibility indication indicative of the compatibility of the classification process to classify an element captured by the sensed information unit.
b. Triggering an allocation of another classification process to classify the test sensed information contingent on the determined compatibility.
c. Routing the augmented versions of a test sensed information unit to the other classification process.
d. Allocating another classification process to classify the test sensed information contingent on the determined compatibility.
e. Triggering a determination of a driving related operation to be executed by the vehicle. The driving related operation may be a fully autonomous operation such as maintaining a current progress of a vehicle, changing a progress of the vehicle, whereas a progress refers to at least one of direction of propagation, speed of propagation and acceleration of the vehicle. Alternatively—the driving related operation is an ADAS operation such as suggesting a driving scheme operation of performing a more limited driving related operation (limited in the sense of its duration).
f. Executing a driving related operation.
g. Triggering executing a driving related operation.
h. Determining a navigation path of the vehicle.
i. Triggering a determining a navigation path of the vehicle
j. Sending to one or more artificial intelligence agents information regarding the classification.
k. Triggering a sending to one or more artificial intelligence agents information regarding the classification
l. Activating one or more artificial intelligence agents based on the classification
m. Triggering an activating one or more artificial intelligence agents based on the classification

For brevity of explanation responses (a)-(m) were not shown in FIG. 2. According to an embodiment, the triggering includes transmitting a signal other than the compatibility indication. The signal may be an interrupt request signal, an arbiter request signal or any other electronic and/or optical signal.

According to an embodiment, method 200 includes executing the classification process to provide the classification data.

According to an embodiment, method 200 does not include the executing of the classification process.

According to an embodiment, step 210 is executed by a processing circuit that executes the classification process.

According to an embodiment, the classification process is an embedding based classification process. An example of an embedding based classification process is illustrated in FIGS. 4-6.

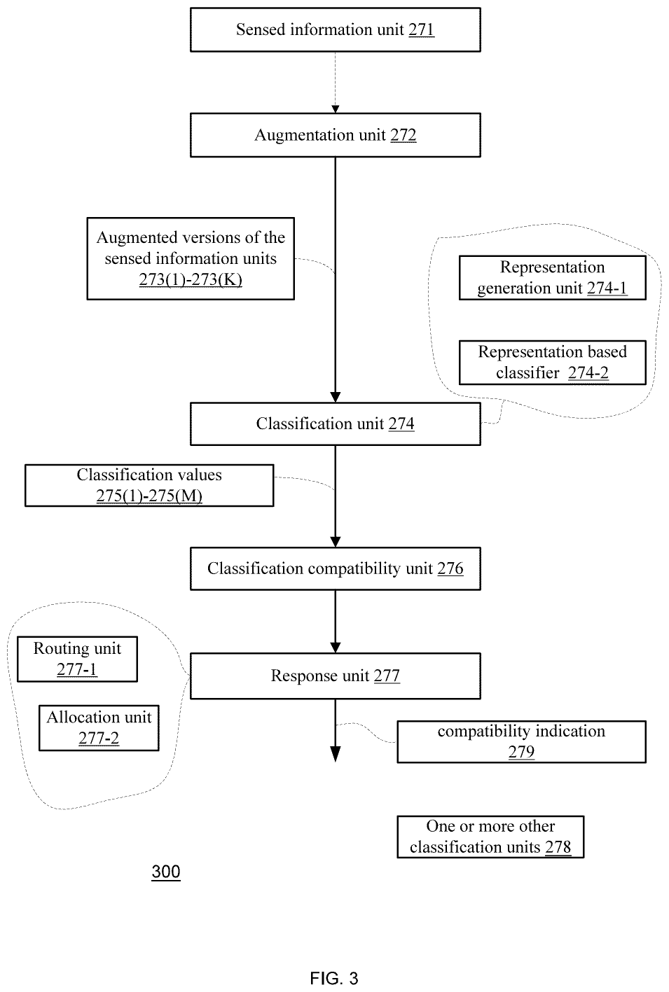

Referring to FIG. 3, a system 300 includes a sensed information unit 271, augmentation unit 272, classification unit 274, classification compatibility unit 276, and a response unit 277. The system 300 may be configured to perform a process that includes:
a. Receiving, by the augmentation unit 272, sensed information provided by the sensed information unit 271.
b. Generating, by the augmentation unit 272 augmented versions 273(1)-273 (K) of the sensed information.
c. Classifying, by the classification unit 274, the generated augmented versions 273(1)-273 (K) of the sensed information to provide classification values 275(1)-275(M) indicative of elements captured by the augmented versions 273(1)-273 (K) of the sensed information. The classification unit may include a representation generation unit 274-1 and a representation based classifier 274-2. A representation may be an embedding, a signature of an embedding, a signature not related to an embedding, and the like.
d. Determining, by the classification compatibility unit 276, the compatibility of the classification process with respect to the received classification data.
e. Responding to the determining by the response unit 277. here, a compatibility indication 279 may be issued by the response unit that includes a routing unit 277-1 and an allocation unit 277-2.

FIG. 3 also illustrates one or more other classification units 278 capable of performing the classification when the classification unit 274 is applied to perform an incompatible classification process.

Any unit is either a hardware unit or is implemented by executing instructions by a processing circuit.

Referring to FIG. 4, an initial sensed information 400 may include an image 901 having a bounding box 902 that is indicative of a location of object 903, a cropped image 904 that mostly includes the pixels of the object 903, an object embedding 910 of the cropped image, a signature 912 of the object embedding, reference embedding signatures clusters 920(1)-920(W) that are represented by reference embedding signatures 921(1)-921(X) (that may or may not be included in the reference embedding signature clusters), where there may be more than one reference embedding signature per reference embedding signature cluster, other reference embedding signatures 922(1)-922 (Y) included in the reference embedding signatures clusters (and differ from the reference embedding signatures 921(1)-921(X)), outliers 925(1)-925(Z) located outside the clusters, reference embedding signatures clusters metadata (923(1)-923(W)) that provide information such as object classification about the clusters, and a matching reference embedding signatures cluster 920(w) that is represented by reference embedding signature 921(w) and is associated with metadata 923(w) indicative of an object classification.

According to an embodiment, the object embedding information item is an object embedding, the reference embeddings information items are reference embeddings, and the reference embedding information items clusters are reference embedding clusters.

According to an embodiment the cropped sensed information unit consists essentially of the information indicative of the object. The cropping increases the accuracy of the object embedding as irrelevant information is mostly removed from the cropped sensed information unit.

According to an embodiment, the cropped sensed information unit was generated based on an initial sensed information unit and a bounding box indicative of the object within the initial sensed information unit.

According to an embodiment, the cropped sensed information was generated based on an initial sensed information unit and a plurality of keypoints within the initial sensed information unit that are associated with the object. Keypoints may be found in any known manner. According to an embodiment, a keypoint is found in the manner illustrated in U.S. Pat. No. 11,037,015 which is incorporated herein by reference.

According to an embodiment, cropped sensed information was generated based on an initial sensed information unit and an initial sensed information unit region that includes a plurality of keypoints within the initial sensed information unit that are associated with the object.

Assuming, that the transformation module (especially an embedding generator within the transformation module) is configured to process content of a given shape—for example it is configured to process a cropped sensed information unit that includes relevant information within a rectangular region of a sensed information unit—then the method includes defining a rectangular region to include the plurality of keypoints (the rectangular region may be defined to be as small as possible—or to include up a limited amount of information outside a smallest region that includes the keypoints)—and to process the content of the rectangular region. The processing may include aligning the rectangular region (which may be oriented to the horizon) before providing the rectangular box to the embedding generator.

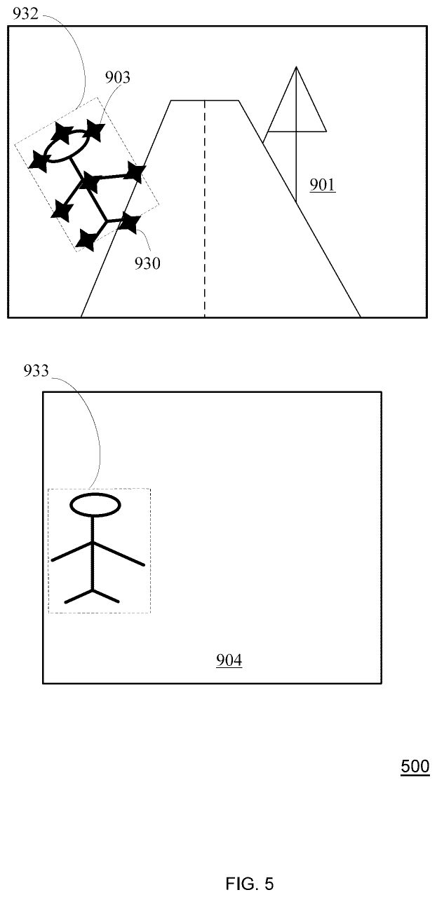

Referring to FIG. 5, a sensed information 500 such as image 950, which has an object 903 including keypoints 930 of the object, and a bounding box 932 that surrounds the keypoints 930; and a cropped image 904. The bounding box 932 is oriented with the object 930, and the cropped image 904 includes an aligned bounding box 933.

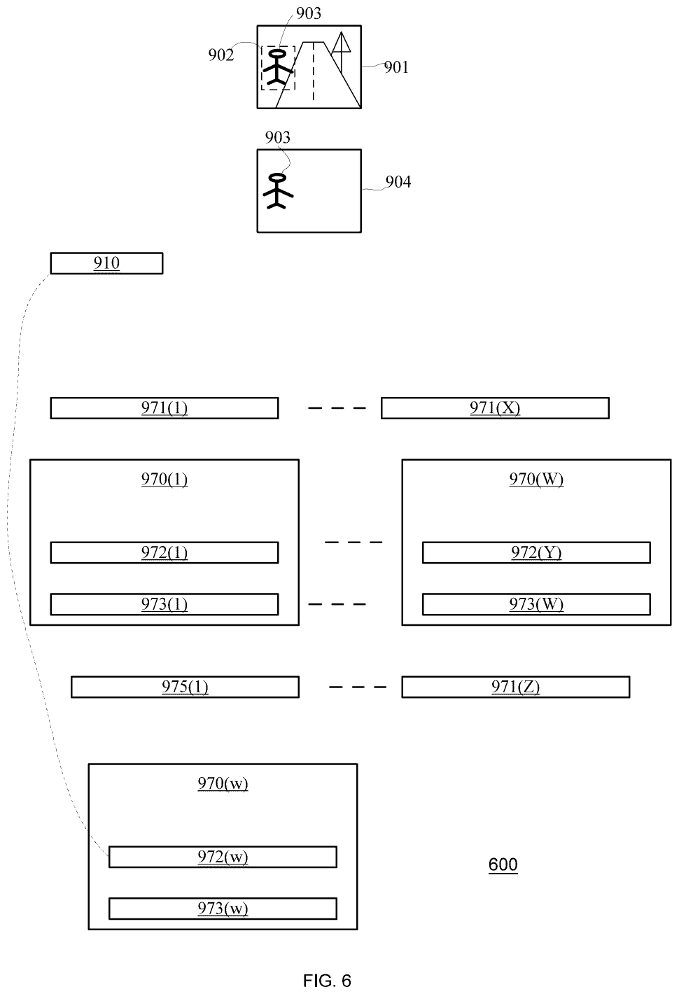

Referring to FIG. 6, an initial sensed information 600 may include an image 901 including a bounding box 902 that is indicative of a location of object 903, a cropped image 904 that mostly includes the pixels of the object 903, an object embedding 910 of the cropped image, reference embedding clusters 970(1)-970(W) that are represented by reference embedding 971(1)-971(X), where there may be more than one reference embedding per reference embedding cluster, other reference embedding 972(1)-972(Y) included in the reference embedding clusters (and differ from the reference embedding 971(1)-971(X)), outliers 975(1)-975(Z) located outside the clusters, reference embedding clusters metadata (973(1)-973(W)) that provide information such as object classification about the clusters, and a matching reference embedding cluster 970(w) that is represented by reference embedding 971(w).

In the foregoing detailed description, numerous specific details are set forth in order to provide a thorough understanding of the disclosure. However, it will be understood by those skilled in the art that the present disclosure may be practiced without these specific details. In other instances, well-known methods, procedures, and components have not been described in detail so as not to obscure the present disclosure.

The subject matter regarding the disclosure is particularly pointed out and distinctly claimed in the concluding portion of the specification. The disclosure, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present disclosure may for the most part, be implemented using electronic components and circuits known to those skilled in the art, details will not be explained in any greater extent than that considered necessary as illustrated above, for the understanding and appreciation of the underlying concepts of the present disclosure and in order not to obfuscate or distract from the teachings of the present disclosure.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of transformation module, active learning module, or clustering module, or any other module described herein, may be implemented in hardware and/or code, instructions and/or commands stored in a non-transitory computer readable medium, may be included in a vehicle, outside a vehicle, in a mobile device, in a server, and the like.

The vehicle may be any type of vehicle—such as a ground transportation vehicle, an airborne vehicle, or a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

A situation may be a singular location/combination of properties at a point in time. A scenario is a series of events that follow logically within a causal frame of reference. Any reference to a scenario should be applied mutatis mutandis to a situation.

The sensed information unit may be sensed by one or more sensors of one or more types. The one or more sensors may belong to the same device or system—or may belong to different devices of systems.

A perception unit may be provided and may be preceded by the one or more sensors and/or by one or more interfaces from receiving one or more sensed information units. The perception unit may be configured to receive a sensed information unit from an I/O interface and/or from a sensor. The perception unit may be followed by multiple narrow AI agents—also referred to as an ensemble of narrow AI agents.

A sensed information unit may or may not be processed before reaching the perception unit. Any processing may be providing—filtering, noise reduction, and the like.

Further Embodiments are listed below.

Embodiment 1. A method that is computer implemented for classification process evaluation, including receiving, at a processing circuit, classification data generated by a classification process for augmented versions of a test sensed information unit; evaluating the classification data across the augmented versions, by analyzing a distribution of selected classification values of the classification data; determining, based on the evaluation, a compatibility of the classification process with respect to the received classification data; and issuing a compatibility indication in accordance with the determined compatibility, the compatibility indication indicative of the compatibility of the classification process to classify an element captured by the test sensed information unit.

Embodiment 2. The method of Embodiment 1, further including triggering an allocation of another classification process to classify the test sensed information contingent on the determined compatibility.

Embodiment 3. The method of any of Embodiments 1-2, further including routing the augmented versions of the test sensed information unit to the other classification process.

Embodiment 4. The method of any of Embodiments 1-3, wherein the augmented versions of the test sensed information unit are generated by using one or more machine learning processes.

Embodiment 5. The method of any of Embodiments 1-4, further including applying the classification process to provide the classification data.

Embodiment 6. The method of any of Embodiments 1-5, including determining that the classification process is capable of classifying the test sensed information unit when the classification values are statistically significant.

Embodiment 7. The method of any of Embodiments 1-6, including determining that the classification process is capable of classifying the test sensed information unit when at least a defined percent of the classification values are the same.

Embodiment 8. The method of any of Embodiments 1-7, wherein the classification process is an embedding-based classification process.

Embodiment 9. A non-transitory computer readable medium for classification process evaluation, the non-transitory computer readable medium stores instructions that once executed by a computerized system cause the object computerized system to: receive classification data generated by a classification process for augmented versions of a test sensed information unit; evaluate the classification data across the augmented versions, by analyzing a distribution of selected classification values of the classification data; determine, based on the evaluation, a compatibility of the classification process with respect to the received classification data; and issue a compatibility indication in accordance with the determined compatibility, the compatibility indication indicative of the compatibility of the classification process to classify an element captured by the test sensed information unit.

Embodiment 10. The non-transitory computer readable medium of Embodiment 9, further storing instructions for triggering an allocation of another classification process to classify the test sensed information contingent on the determined compatibility.

Embodiment 11. The non-transitory computer readable medium of any of Embodiments 9-10, further storing instructions for routing the augmented versions of the test sensed information unit to the other classification process.

Embodiment 12. The non-transitory computer readable medium of any of Embodiments 9-11, wherein the augmented versions of the test sensed information unit are generated by using one or more machine learning processes.

Embodiment 13. The non-transitory computer readable of any of Embodiments 9-12, further storing instructions for applying the classification process to provide the classification data.

Embodiment 14. The non-transitory computer readable medium of any of Embodiments 9-13, including determining that the classification process is capable of classifying the test sensed information unit when the classification values are statistically significant.

Embodiment 15. The non-transitory computer readable medium of any of Embodiments 9-14, including determining that the classification process is capable of classifying the test sensed information unit when at least a defined percent of the classification values are the same.

Embodiment 16. The non-transitory computer readable medium of any of Embodiments 9-15, wherein the classification process is an embedding-based classification process.

Embodiment 17. A computerized system of classification process evaluation, the computerized system includes: a memory unit that is configured to store classification data generated by a classification process for augmented versions of a test sensed information unit; and a processing circuit that is configured to: evaluate the classification data across the augmented versions, by analyzing a distribution of selected classification values of the classification data; determine, based on the evaluation, a compatibility of the classification process with respect to the received classification data; and issuing a compatibility indication in accordance with the determined compatibility, the compatibility indication indicative of the compatibility of the classification process to classify an element captured by the test sensed information unit.

Embodiment 18. The computerized system of Embodiment 17, wherein the processing circuit is further configured to trigger an allocation of another classification process to classify the test sensed information contingent on the determined compatibility.

Embodiment 19. The computerized system of any of Embodiments 17-18, wherein the processing circuit is further configured to rout the augmented versions of the test sensed information unit to the other classification process.

Embodiment 20. The computerized system of any of Embodiments 17-19, wherein the augmented versions of the test sensed information unit are generated by using one or more machine learning processes.

We claim:

1. A method that is computer implemented for classification process evaluation, comprising:
receiving, at a processing circuit, classification data generated by a classification process for augmented versions of a test sensed information unit;
evaluating the classification data across the augmented versions, by analyzing a distribution of selected classification values of the classification data;
determining, based on the evaluation, a compatibility of the classification process with respect to the received classification data; and
issuing a compatibility indication in accordance with the determined compatibility, the compatibility indication indicative of the compatibility of the classification process to classify an element captured by the test sensed information unit.

2. The method according to claim 1, further comprising triggering an allocation of another classification process to classify the test sensed information contingent on the determined compatibility.

3. The method according to claim 3, further comprising routing the augmented versions of the test sensed information unit to the other classification process.

4. The method according to claim 1, wherein the augmented versions of the test sensed information unit are generated by using one or more machine learning processes.

5. The method according to claim 1, further comprising applying the classification process to provide the classification data.

6. The method according to claim 1, comprising determining that the classification process is capable of classifying the test sensed information unit when the classification values are statistically significant.

7. The method according to claim 1, comprising determining that the classification process is capable of classifying the test sensed information unit when at least a defined percent of the classification values are the same.

8. The method according to claim 1, wherein the classification process is an embedding-based classification process.

9. A non-transitory computer readable medium for classification process evaluation, the non-transitory computer readable medium stores instructions that once executed by a computerized system cause the object computerized system to:
receive classification data generated by a classification process for augmented versions of a test sensed information unit;
evaluate the classification data across the augmented versions, by analyzing a distribution of selected classification values of the classification data;
determine, based on the evaluation, a compatibility of the classification process with respect to the received classification data; and
issue a compatibility indication in accordance with the determined compatibility, the compatibility indication indicative of the compatibility of the classification process to classify an element captured by the test sensed information unit.

10. The non-transitory computer readable medium according to claim 9, further storing instructions for triggering an allocation of another classification process to classify the test sensed information contingent on the determined compatibility.

11. The non-transitory computer readable medium according to claim 10, further storing instructions for routing the augmented versions of the test sensed information unit to the other classification process.

12. The non-transitory computer readable medium according to claim 9, wherein the augmented versions of the test sensed information unit are generated by using one or more machine learning processes.

13. The non-transitory computer readable medium according to claim 9, further storing instructions for applying the classification process to provide the classification data.

14. The non-transitory computer readable medium according to claim 9, comprising determining that the classification process is capable of classifying the test sensed information unit when the classification values are statistically significant.

15. The non-transitory computer readable medium according to claim 9, comprising determining that the classification process is capable of classifying the test sensed information unit when at least a defined percent of the classification values are the same.

16. The non-transitory computer readable medium according to claim 9, wherein the classification process is an embedding-based classification process.

17. A computerized system of classification process evaluation, the computerized system comprises:
a memory unit that is configured to store classification data generated by a classification process for augmented versions of a test sensed information unit; and
a processing circuit that is configured to:
evaluate the classification data across the augmented versions, by analyzing a distribution of selected classification values of the classification data;
determine, based on the evaluation, a compatibility of the classification process with respect to the received classification data; and
issuing a compatibility indication in accordance with the determined compatibility, the compatibility indication indicative of the compatibility of the classification process to classify an element captured by the test sensed information unit.

18. The computerized system of claim 17, wherein the processing circuit is further configured to trigger an allocation of another classification process to classify the test sensed information contingent on the determined compatibility.

19. The computerized system of claim 18, wherein the processing circuit is further configured to rout the augmented versions of the test sensed information unit to the other classification process.

20. The computerized system of claim 17, wherein the augmented versions of the test sensed information unit are generated by using one or more machine learning processes.
